(19) United States
(12) Patent Application Publication
(10) Pub. No.: US 2015/0222455 A1
(43) Pub. Date: Aug. 6, 2015

(54) COMMUNICATION SYSTEM

(71) Applicant: DENSO CORPORATION, Kariya-city (JP)

(72) Inventors: Shigeki OHTSUKA, Kariya-city (JP); Hironobu AKITA, Okazaki-city (JP); Nobuaki MATSUDAIRA, Kariya-city (JP); Takahisa YOSHIMOTO, Kariya-city (JP)

(21) Appl. No.: 14/584,015

(22) Filed: Dec. 29, 2014

(30) Foreign Application Priority Data
Jan. 31, 2014 (JP) 2014-16925

(51) Int. Cl. H04L 25/02; H04B 1/40; H04L 5/20

(52) U.S. Cl. CPC H04L 25/0272; H04L 5/20; H04B 1/40

(57) ABSTRACT

A communication system including multiple communication nodes is provided. Each of the multiple communication nodes includes a low speed communication transceiver that is directly connected to a differential communication channel, and a high speed communication transceiver that is AC coupled to the differential channel. The multiple communication nodes include a sending communication node. The sending communication node sends a command to switch from the low speed communication to a high speed communication when the sending communication node performs a low speed communication using the low speed communication transceiver. The sending communication node initiates the high speed communication using the high speed communication transceiver.

### CROSS REFERENCE TO RELATED APPLICATION

This application is based on Japanese Patent Application No. 2014-16925 filed on Jan. 31, 2014, the disclosure of which is incorporated herein by reference.

### TECHNICAL FIELD

The present disclosure relates to a communication system that is switchable communication speed in a differential communication channel.

### BACKGROUND

Patent Literature 1: JP 2012-65096 A (corresponding to US 2012/0051241A1)

CAN (controller area network, a registered trademark) is known as an onboard communication network. A communication speed of CAN is about 1 Mbps. Since the number of ECUs (electronic controller units) mounted to a vehicle increase, an improvement of the communication speed may be required.

As a high speed communication protocol, for example, an onboard Ethernet (a registered trademark) having about 100 Mbps is known.

However, when the onboard Ethernet is installed actually, a dedicated communication channel may be required separately and a cost including a development cost may increase.

CAN-FD (CAN with flexible data rate, a registered trademark) having about 8 Mbps as a maximum communication speed is proposed. In CAN-FD, a transfer of data and CRC (cyclic redundancy check) only is accelerated, so that it may be possible to use a CAN communication channel, which is a low speed.

The applicants of the present disclosure have found the following.

In CAN-FD, only the communication speed is accelerated, DC characteristics of signal amplitude or the like is identical with CAN, and a transceiver used in CAN-FD has a circuit similar to a circuit used in CAN. In a case of an automobile, so that a transceiver is prevented from being destroyed even when a communication channel is short-circuited to a battery power voltage, a high withstand voltage element may be used in a circuit configuring the transceiver. An upper limit of the communication speed may be limited by frequency characteristics of the circuit element.

In order to perform the high speed communication at 100 Mbps order such as the onboard Ethernet, the transceiver may be configured from a miniaturized and high speed element. However, it may be impossible to directly connect the element to the communication channel such as CAN since the miniaturized and high speed element has a low withstand voltage.

### SUMMARY

It is an object of the present disclosure to provide a communication system that perform high speed communication in a low speed differential communication channel whose circuit element has a high withstand voltage.

According to one aspect of the present disclosure, a communication system including multiple communication nodes is provided. Each of the multiple communication nodes includes a low speed communication transceiver that is directly connected to a differential communication channel, and a high speed communication transceiver that is AC coupled to the differential channel. The multiple communication nodes include a sending communication node. The sending communication node sends a command to switch from the low speed communication to a high speed communication when the sending communication node performs a low speed communication using the low speed communication transceiver. The sending communication node initiates the high speed communication using the high speed communication transceiver.

According to the communication system, since the high speed communication transceiver is AC coupled to the differential communication channel, a circuit element with a low withstand voltage operating at high speed configuring the high speed communication transceiver is prevented from being destroyed even when the differential communication channel is short-circuited to a direct current. Therefore, it may be possible to substantially improve the communication speed. It may be possible to perform high speed communication in a low speed differential communication channel.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a drawing illustrating a configuration of communication system in a first embodiment;

FIG. 2 is a drawing illustrating a specific configuration of a low speed transceiver and a high speed transceiver;

FIG. 3 is a drawing illustrating an example of a communication procedure including a communication frame used in a high speed communication;

FIG. 4 is a flow chart illustrating a processing in a receiving node corresponding to the communication procedure described in FIG. 3.

FIG. 5 is a drawing illustrating differential signal waveforms in a low speed communication and a high speed communication;

FIG. 6 is a drawing illustrating differential signal waveforms in a low speed communication and a high speed communication in a second embodiment; and

FIG. 7 is a drawing illustrating differential signal waveforms in a low speed communication and a high speed communication in a third embodiment.

### DETAILED DESCRIPTION

### First Embodiment

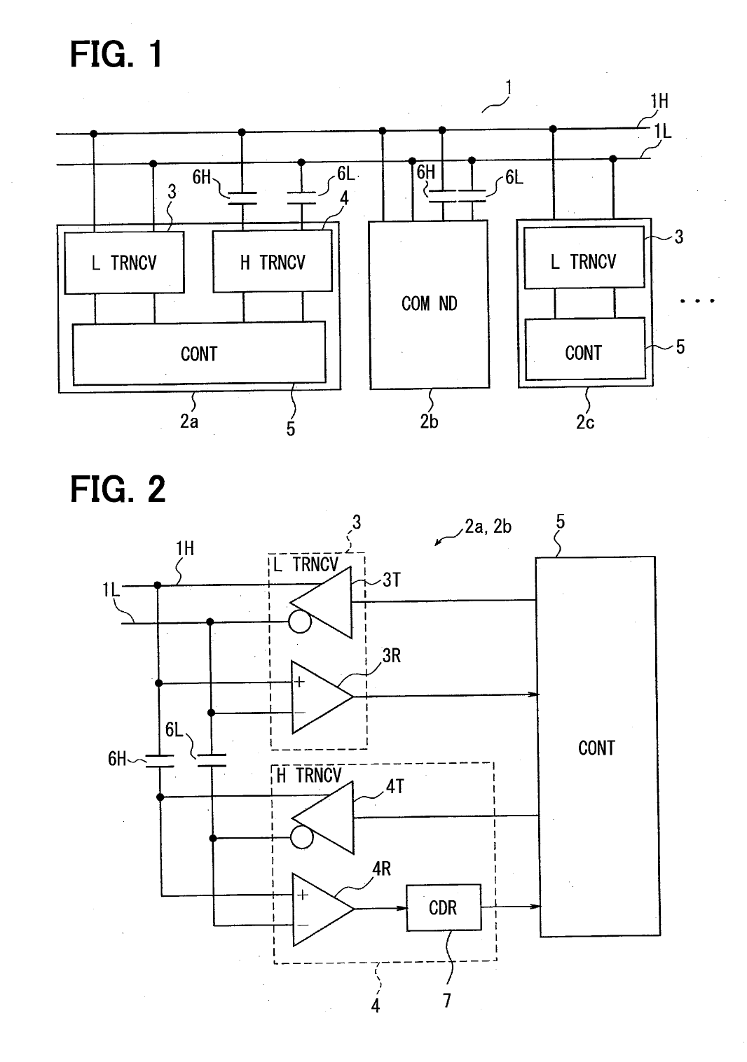

The first embodiment will be explained. As described in FIG. 1, a communication system in the present disclosure is configured from a differential communication channel 1, and multiple communication nodes 2a, 2b, 2c, etc. The differential communication channel 1 includes a pair of communication lines (also referred to as signal lines) 1H, 1L. The multiple communication nodes 2a, 2b, 2c, etc. are connected to the differential communication channel 1. Each of the communication nodes 2a, 2b includes a low speed transceiver 3, a high speed transceiver 4, and a control circuit 5. The communication node 2c includes the low speed transceiver 3 and the control circuit 5. Incidentally, the low speed transceiver 3 may be referred to as a low speed communication transceiver. The high speed transceiver 4 may be referred to as a high speed communication transceiver. In addition, both ends of the communication lines 1H, 1L are terminated by a terminal resistance (not shown).

The low speed transceiver 3 is directly connected to the communication lines 1H, 1L. The high speed transceiver 4 is connected to the communication lines 1H, 1L through capacitors 6H, 6L. That is, the high speed transceiver 4 is AC coupled to the communication lines 1H, 1L. The control circuit 5 is configured from a microcomputer. The control circuit 5 transmits a signal to another communication node 2 or receives a signal transmitted from another communication node 2 while using either one of the transceivers 3, 4

As described in FIG. 2, the low speed transceiver 3 is configured from a driver 3T and a comparator 3R. The driver 3T drives the communication lines 1H, 1L according to a binary level signal outputted from the control circuit 5 and transmits the differential signal. The comparator 3R converts the differential signal received from the communication lines 1H, 1L to a binary level signal and outputs the binary level signal to the control circuit 5. The high speed transceiver 4 includes a driver 4T and a comparator 4R, which are similar to the driver 3T and the comparator 3R respectively. An signal of the comparator 4R is outputted to the control circuit 5 through a clock and data recovery circuit 7 (hereinafter, referred to as a CDR circuit 7).

The low speed transceiver 3 is configured from a circuit element having a high withstand voltage and a low operation speed. Incidentally, the high withstand voltage corresponds to a withstand voltage that the circuit element may not be broken even when the communication system in the present disclosure is implemented to, for example, an onboard communication and the differential communication channel 1 is short-circuited to a battery power source of a vehicle. The high speed transceiver 4 is configured from a circuit element having a low withstand voltage and a high operation speed. The control circuit 5 uses the low speed transceiver 3 when performing a communication at a low speed and uses the high speed transceiver 4 when performing the communication at a high speed.

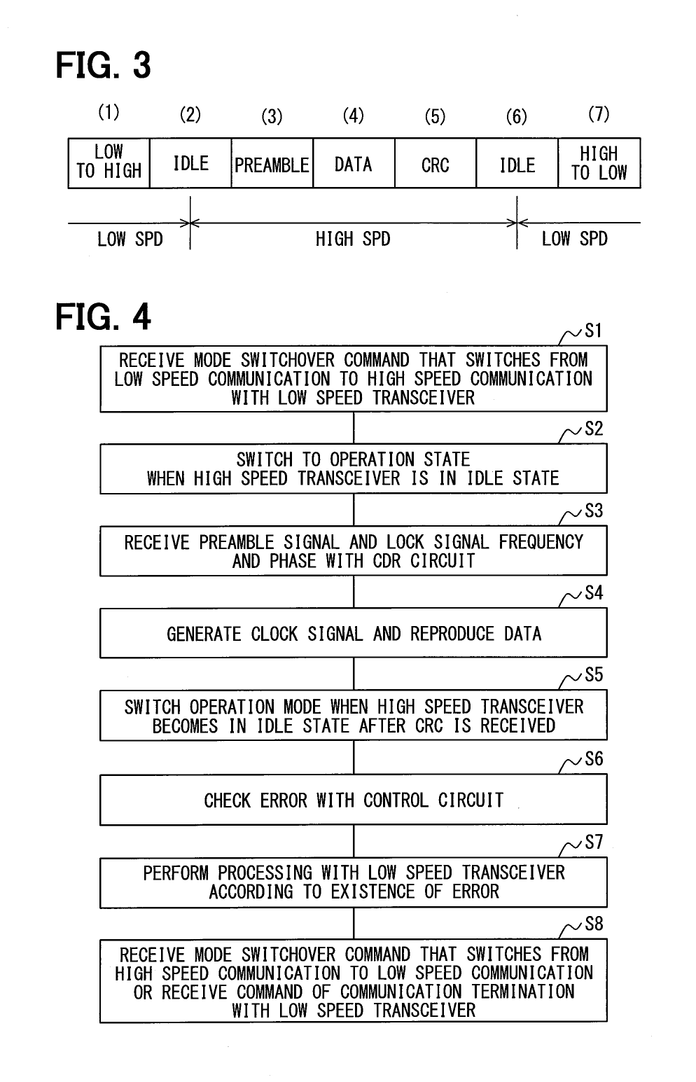

The low speed transceiver 3 transmits a communication frame including a SOF, an arbitration field, a control field, a data field, a CRC field, ACK, EOF, or the like, for example, conforming to CAN when the low speed transceiver 3 performs a low speed communication. When the low speed communication is switched to a high speed communication (that is, when a communication mode switching is performed), a communication procedure described in FIG. 3 is performed.

(1) Initially, the low speed transceiver 3 in a sending node sends a command for switching a communication speed from the low speed to the high speed.

(2) Next, a predetermined idle period is provided. In the idle period, a signal state of the differential communication channel 1 is maintained constant. In a case of, for example, CAN, either a recessive state (corresponding to a non-drive state) or a dominant state (corresponding to a drive state) is maintained. Since the high speed transceiver 4 is connected to the differential communication channel 1 through a coupling capacitor, it may be necessary to stabilize a DC level of the high speed transceiver 4 over a time constant including a capacity. In addition, in the idle period, the communication mode in a receiving node is switched to the high speed.

(3) The sending node initiates the high speed communication with the high speed transceiver 4 and sends a preamble. So that the preamble presents a frequency corresponding to a communication rate in the high speed communication, the high speed transceiver 4 sends the preamble with a signal form indicating the frequency. At the time of a sending of the preamble, the receiving node extracts frequency information and phase information from the preamble with the CDR circuit 7 and is locked to the frequency and the phase. The receiving node supplies the control circuit 5 with a clock signal, which corresponds to the communication rate.

(4) Subsequently, the high speed transceiver 4 in the sending node sends data to the differential communication channel 1.

(5) In addition, the high speed transceiver 4 sends a CRC (cyclic redundancy check corresponding to an error detection code) to the differential communication channel 1.

(6) When the high speed communication completes, the predetermined idle period is provided, and the DC level in the differential communication channel 1 is stabilized.

(7) The low speed transceiver 3 in the sending node sends a command for switching the communication speed from the high speed to the low speed.

Incidentally, the above steps of (1) to (7) are repeated when any one of the communication nodes 2 initiates the high speed communication.

As described in FIG. 4, the low speed transceiver 3 in the receiving node receives the mode switching command, which instructs a mode switching to the high speed communication (S1). In this step, when the high speed transceiver 4 in the receiving node is in a waiting state (for example, when an operation power is cut off), the high speed transceiver 4 is switched to an operation state (S2). Subsequently, the receiving node receives the preamble, which is sent by the high speed communication, and extracts the frequency information and the phase information with the CDR circuit 7. The receiving node locks the frequency (S3). The CDR circuit 7 generates the clock signal having the frequency and reproduces a receiving data (S4).

When the receiving of the CRC completes, the receiving node switches the operation mode of the high speed transceiver 4 to the waiting state in a case where the high speed transceiver 4 is changed to the waiting state. Subsequently, the control circuit 5 checks whether an error occurs based on the received CRC (S6). The low speed transceiver 3 in the receiving node performs an action corresponding to whether there is an error (S7). That is, an acknowledgement is returned when there is no error. An action including a sending of a re-transmission request is performed when there is an error. The receiving node receives a command for switching the communication speed from the high speed to the low speed.

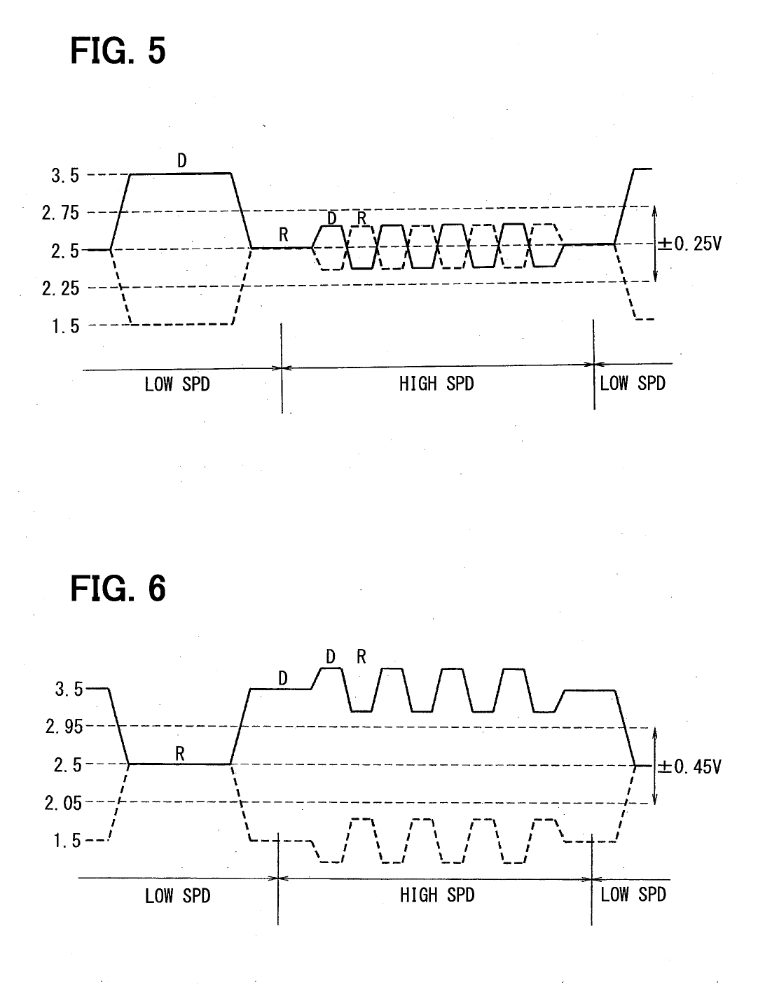

As described in FIG. 5, the low speed communication is performed, confirming to CAN. The low speed communication sends the recessive (also referred to a recessive bit) or the dominant (also referred to a dominant bit). Incidentally, in the recessive, the differential communication channel 1 is in the non-drive state, and the recessive corresponds to a low level of the differential signal and has a data value of one. In the dominant, the differential communication channel 1 is in the drive state, and the dominant corresponds to a high level of the differential signal and has the data value of zero. An electric potential of the communication lines 1H, 1L in the recessive at the time of the low speed communication is equal to, for example, 2.5 V (corresponding to a center voltage), and the electric potentials of the communication line 1H and the communication line 1L in the dominant are equal to, for example, 3.5 V and 1.5 V respectively. In the dominant, the difference voltage is equal to 2.0 V. In the idle time when the low speed communication is switched to the high speed communication, the state of the recessive remains for a predetermined period.

In this case, amplitude of the differential signal in the high speed communication is set within a range that does not exceed a determination threshold for detecting the recessive. For example, when the threshold is equal to 0.5 V, amplitude variation of each of a signal line 1H and a signal line 1L in the high speed communication is set within a range from 2.25 V to 2.75 V.

The dominant corresponds to, for example, a state where the communication line 1H corresponds to the high level and the communication line 1L corresponds to the low level. The recessive corresponds to a state where the communication line 1H corresponds to the low level and the communication line 1L corresponds to the high level. When it is supposed that the high level is equal to 2.7 V and the low level is equal to 2.3 V, the difference voltage in the dominant is equal to 0.4 V and the difference voltage in the recessive is equal to −0.4 V. In this case, since it is unlikely to exceed the determination threshold of the recessive in the low speed communication, it may not be determined that a signal state of the differential communication channel 1 has changed even when the low speed transceiver 3 operates during an operation of the high speed communication.

According to the present disclosure, each of the communication nodes 2a, 2b includes the low speed transceiver 3, which is directly connected to the differential communication channel 1, and the high speed transceiver 4, which is connected to the differential communication channel through a coupling capacitor. The sending communication node 2 sends the command for switching to the high speed communication and initiates the high speed communication with the high speed transceiver 4 when the low speed transceiver 3 performs the low speed communication. According to this configuration, since the high speed transceiver 4 is connected to the differential communication channel 1 through the capacitor coupling, a circuit element configuring the high speed transceiver 4 may not be destroyed even when the differential communication channel 1 is short-circuited to, for example, a power supply voltage of a battery mounted to a vehicle. Therefore, it may be possible to substantially improve the communication speed with the high speed transceiver 4 as compared with the conventional communication speed, and it may be possible that the high speed communication, for example, exceeding 100 Mbps is executable.

Incidentally, the sending communication node corresponds to a communication node that sends a signal, a command, or the like. A receiving communication node corresponds to a communication node that receives a signal, a command, or the like.

In addition, since the sending node sends the command for switching to the low speed communication and switches to the low speed communication when the sending node completes the high speed communication, it may be possible that the receiving node surely detects a shift from the high speed communication to the low speed communication. Since the communication node 2 transfers the preamble, the data, and the CRC by the high speed communication, it may be possible to be directly applied to a communication protocol including, for example, an existing CAN-FD.

In addition, the CDR circuit 7 provided to a receiver of the high speed transceiver 4 detects the clock frequency from the preamble while the CDR circuit 7 receives the preamble, and locks the frequency. The CDR circuit 7 supplies a clock signal used in the subsequent high speed communication. Thus, it may be possible that the receiving node performs a receiving processing even when a communication speed of the high speed communication is determined arbitrarily.

In addition, the amplitude variation of the differential signal at the time when the high speed transceiver 4 performs the high speed communication does not cross over the determination threshold of the differential signal at the time when the low speed transceiver 3 performs the low speed communication. Specifically, the differential communication channel 1 is in the recessive state during the idle time immediately before the initiation of the high speed communication. The amplitude variation of the differential signal at the time of the high speed communication is set less than the determination threshold of the recessive (corresponding to a low level determination threshold). Therefore, even when the low speed transceiver 3 operates during executing the high speed communication, it may not be determined that the signal state of the differential communication channel 1 is changed and it may not be necessary to perform any special processing. Therefore, a control may be simplified.

In other words, the high speed communication transceiver controls a signal state of the differential communication channel to remain the differential signal below a low level determination threshold for a predetermined period immediately before an initiation of the high speed communication. The amplitude variation of the differential signal in the high speed communication is less than the low level determination threshold.

### Second Embodiment

Followingly, the parts identical with the first embodiment will be given to the identical symbols and a different part will be explained mainly. In the second embodiment, as described in FIG. 6, the differential communication channel 1 is in the dominant state during the idle period when the low speed communication is switched to the high speed communication. In this case, the amplitude of the differential signal in the high speed communication is set to a range that does not cross over (that is, is not lower than) a determination threshold of the differential signal for determining the dominant. The determination threshold for the dominant corresponds to a high level determination threshold. In other words, it is required to be determined that the differential signal remains the dominant during the high speed communication in the second embodiment. For example, when the determination threshold is equal to 0.9 V, the amplitude variation of the signal line 1H in the high speed communication is more than 2.95 V and the amplitude variation of the signal line 1L is less than 2.05 V.

Herein, for example, the dominant corresponds to a state where the communication line 1H corresponds to the high level and the communication line 1L corresponds to the low level. The recessive corresponds to a state where the communication line 1H corresponds to the low level and the communication line 1L corresponds to the high level. Incidentally, in the second embodiment, the high level and the low level of the communication lines 1H, 1L are different. For example, the high level of the communication line 1H is set to 3.7 V and the low level is set to 3.3 V. The high level of the communication line 1L is set to 1.7 V and the low level is set to 1.3 V.

In this case, the difference voltage corresponding to the dominant is equal to 2.4 V, and the difference voltage corresponding to the recessive is equal to 1.6 V. Therefore, it is unlikely that the amplitude of the differential signal crosses over (that is, is below) the determination threshold in the recessive in the low speed communication.

In other words, the high speed communication transceiver controls a signal state of the differential communication channel to remain the differential signal over a high level determination threshold for a predetermined period immediately before an initiation of the high speed communication, and the amplitude variation of the differential signal in the high speed communication is more than the high level determination threshold.

According to the second embodiment, the differential communication channel 1 is in the dominant state during the idle period immediately before an initiation of the high speed communication. The amplitude variation of the differential signal when the high speed transceiver 4 performs the high speed communication exceeds the determination threshold of the dominant. Therefore, the technical effects similar to the first embodiment will be obtained.

### Third Embodiment

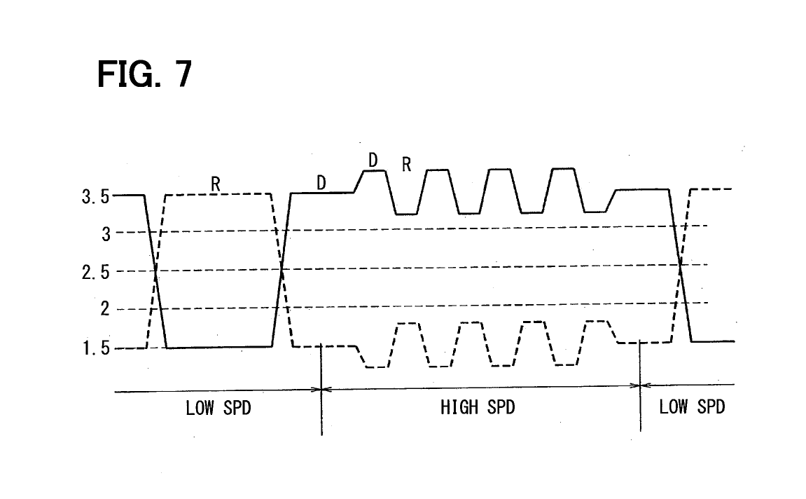

In the third embodiment, a relationship of the dominant and the recessive in the low speed communication is similar to a pattern in the high speed communication in the first embodiment as described in FIG. 7. In the low speed communication, the dominant corresponds to a state where the communication line 1H corresponds to the high level (3.5 V) and the communication line 1L corresponds to the low level (1.5 V). The recessive corresponds to a state where the communication line 1H corresponds to the low level (1.5 V) and the communication line 1L corresponds to the high level (3.5 V). Incidentally, the difference voltage in the dominant is equal to 2.0 V. The difference voltage in the recessive is equal to −2.0 V.

In this case, the differential communication channel 1 is in the dominant state during the idle period at the time when the low speed communication is switched to the high speed communication. The high speed communication may be realized applying the amplitude variation of the differential signal similar to the second embodiment.

It should be noted that the present disclosure is not limited to the embodiments explained or described in the drawings, and that the modification or expansion may be possible.

Alternatively, one or more different communication nodes may be connected to the differential communication channel 1 separately. The different communication node includes a different high speed communication receiver configured only from a receiver having the comparator 4R and the CDR circuit 7 without the driver 4T in the sending portion. In other words, the high speed transceiver 4 in the communication node 2 in FIG. 2 may be substituted with the different high speed communication receiver.

Alternatively, instead of the command for switching a communication speed from the low speed to the high speed, a bit of a control field may be allocated.

Incidentally, the idle period may not be necessary, and the idle period may be provided only when it is required to stabilize the DC level of the communication lines 1H, 1L at the time when the shift between the low speed communication and the high speed communication.

Alternatively, instead of the command for switching the communication speed from the high speed to the low speed, a command instructing a termination of the high speed communication may be sent. For example, a bit of EOF may be allocated.

The error detection code is not limited to CRC, and another code may be used.

The low speed communication may not be necessary to conform to a protocol of CAN.

When a communication rate in the high speed communication is known or predetermined, the CDR circuit 7 may not be necessary.

A specific value of a voltage level corresponding to each signal state may be appropriately changed according to a specific design.

According to a communication system in the present disclosure, the communication system includes multiple communication nodes. Each of the multiple communication node includes a low speed communication transceiver that is directly connected to a differential communication channel, and a high speed communication transceiver that is AC coupled to the differential channel. Incidentally, a communication node that includes only the low speed transceiver may be mixed into the communication system. The multiple communication nodes include a sending communication node and a receiving communication node according to its function. The sending communication node sends a command to switch from the low speed communication to a high speed communication when the sending communication node performs a low speed communication using the low speed communication transceiver. The sending communication node initiates the high speed communication using the high speed communication transceiver.

According to this configuration, since the high speed communication transceiver is AC coupled to the differential communication channel, a circuit element with a low withstand voltage operating at high speed configuring the high speed communication transceiver is prevented from being destroyed even when the differential communication channel is short-circuited to a direct current. Therefore, it may be possible to substantially improve the communication speed as compared with the conventional communication speed.

According to the communication system in the present disclosure, since the sending communication node sends the command for switching the communication speed to another communication node and the receiving communication node switches from the high speed communication to the low speed communication, it may be possible that the receiving communication node surely determines a shift from the high speed communication to the low speed communication.

According to the communication system in the present disclosure, the communication node transfers the preamble, the data, and the error detection code at the high speed communication.

According to the communication system in the present disclosure, the clock and data recovery circuit provided to the receiving portion of the high speed communication transceiver detects the clock frequency from the preamble while receiving the preamble and locks the frequency. The clock and data recovery circuit supplies the clock signal used in the subsequent high speed communication. Therefore, it may be possible that the receiving communication node performs a receiving processing corresponding to any arbitral communication speed in the high speed communication.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A communication system comprising
a differential communication channel, and
a plurality of communication nodes connected to the differential communication channel, wherein
each of the communication nodes includes:
a low speed communication transceiver that is directly connected to the differential communication channel; and
a high speed communication transceiver that is AC coupled to the differential communication channel,
a sending communication node of the communication nodes sends a command for switching from a low speed communication to a high speed communication when the sending communication node performs the low speed communication using the low speed communication transceiver, and
the sending communication node initiates the high speed communication using the high speed communication transceiver.

2. The communication system according to claim 1, wherein
the sending communication node sends the command for switching from the high speed communication to the low speed communication when the high speed communication completes, and
the sending communication node is switched to the low speed communication.

3. The communication system according to claim 1, wherein
the communication nodes transfer a preamble, a data, and an error detection code in the high speed communication.

4. The communication system according to claim 3, wherein
a receiver of the high speed communication transceiver includes a clock and data recovery circuit,
the clock and data recovery circuit detects a clock frequency from the preamble while receiving the preamble, and locks the clock frequency,
the clock and data recovery circuit supplies a clock signal corresponding to the clock frequency, and
the clock signal is used in the high speed communication that is performed subsequently.

5. The communication system according to claim 4 further comprising
a plurality of other communication nodes including:
the low speed communication transceiver; and
a high speed communication receiver with only an other receiver that is AC coupled to the differential communication channel, wherein
the other receiver in the high speed communication receiver performs a receiving processing.

6. The communication system according to claim 1, wherein
an amplitude variation of a differential signal in the high speed communication in the high speed communication transceiver does not cross over a determination threshold of the differential signal in the low speed communication performed by the low speed communication transceiver.

7. The communication system according to claim 6, wherein
the high speed communication transceiver controls a signal state of the differential communication channel to remain the differential signal below a low level determination threshold for a predetermined period immediately before an initiation of the high speed communication, and
the amplitude variation of the differential signal in the high speed communication is less than the low level determination threshold.

8. The communication system according to claim 6, wherein
the high speed communication transceiver controls a signal state of the differential communication channel to remain the differential signal over a high level determination threshold for a predetermined period immediately before an initiation of the high speed communication, and
the amplitude variation of the differential signal in the high speed communication is more than the high level determination threshold.
